(19) United States
(12) Patent Application Publication
(10) Pub. No.: US 2002/0161642 A1
(43) Pub. Date: Oct. 31, 2002

(54) Method for distributing coupons via in-store photo processing equipment

(76) Inventors: Steven H. Schultz, Princeton, NJ (US); Robert S. Ripp, Chatham, NJ (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/109,381

(22) Filed: Mar. 28, 2002

Related U.S. Application Data
(60) Provisional application No. 60/280,793, filed on Apr. 2, 2001.

(51) Int. Cl. G06F 17/60

(52) U.S. Cl. 705/14

(57) ABSTRACT

The method in accordance with this invention involves the use of in-store photo processing equipment. A coupon is distributed to a consumer via the consumer's completed photo processing order. When submitting film for development, or working with a photo kiosk with existing processed film, the consumer provides specific consumer profile information. The in-store photo processing equipment accesses an in-store profile information database to retrieve consumer profile information based upon the specific consumer profile information provided by the consumer. A coupon is selected using the profile information provided by the consumer and examined in the profile information database. The selected coupon is then distributed to the consumer via the completed photo processing order.

### 1. RELATED APPLICATIONS

This application claims the benefit of U.S. provisional application Serial No. 60/280,973 filed Apr. 2, 2001, hereby incorporated by reference in its entirety.

### 2. FIELD OF THE INVENTION

This application relates to a method of distributing coupons, and more particularly, to a method of distributing coupons based upon consumer profile information wherein the coupons are distributed at the point of photo processing.

### 3. BACKGROUND OF THE INVENTION

Consumer packaged goods (“CPG”) manufacturers and retailers distribute coupons to both maintain current consumers of their products, and to obtain broader market share by focusing on consumers who purchase competitive products. Typical coupon distribution includes FSI (freestanding insert-Sunday coupon inserts), in-store UPC triggered coupons (coupons that are printed after a product has been scanned), and “Take Ones” (tear pads or coupon dispensing machines located at the product shelf).

Manufacturers also pay for database driven targeting via loyalty card programs in addition to relying on retail circulars. A large number of retail stores offer discounts via use of a loyalty card. These types of programs have increased sales volume, transaction size, redemption rate and customer traffic while decreasing advertising/marketing spending. In fact, these programs rate as one of the three most important factors affecting a consumer's choice of where to shop (others were location and in-store sales). Loyalty card programs offer consumers special discounts when the loyalty card is produced at the point of sale. Most retail stores maintain a customer profile database which tracks the consumer's use of the card and purchases made at the store.

More retailers, photo and non-photo, are entering the photo processing market by obtaining photo processing equipment (digital and digital/analog hybrid mini-labs) and placing photo kiosks in stores. As such, consumers' immediate processing needs are becoming a standard part of the shopping trip, similar to buying food.

### 4. SUMMARY OF INVENTION

It is desired to provide a method of distributing coupons that target past purchasers of a manufacturer's product. It is desired to provide a method for distributing coupons that evaluates a consumer's purchasing history and selects a coupon that is best suited for that individual consumer's need. It is desired to provide a method for distributing coupons via a consumer's in-store photo processing order. Finally, it is desired to reach consumers with targeted promotional offers before they complete their shopping.

This inventive method leverages the combination of the growing trends in photo finishing and CPG promotional spending. This method connects and uses in-store photo processing equipment and loyalty card programs to distribute coupons at the time of photo finishing. This method also allows for the creation/maintenance of a consumer database in the event a loyalty card program is not available. The in-store photo processing equipment is the perfect point of coupon distribution since consumers typically begin shopping by picking up their photos in-store and reviewing them prior to check out.

These and other objects, advantages and features are achieved by the method in accordance with this invention that involves the use of in-store photo processing equipment. A coupon is distributed to a consumer via the consumer's completed photo processing order. The coupon that is distributed is of the type redeemable in the store itself. The coupon may take the form of “cents off” when a particular item is purchased, a “buy one, get one free” type incentive, or any other incentive tied to a consumer's visit to the facility that processed the consumer's photo order. When submitting film for development, or working with a photo kiosk, or the like, with existing processed film or digital images, the consumer provides a consumer identifier which enables access to specific consumer profile information. With the use of the consumer identifier, the in-store photo processing equipment accesses an in-store profile information database to retrieve the consumer profile information based upon the consumer identifier provided by the consumer. A coupon is selected using the consumer identifier and profile information provided by the consumer and retrieved from the profile information database. The selected coupon(s) are then distributed to the consumer via the completed photo processing order.

The profile information database may contain consumer specific purchasing history and consumer specific demographic information. The selection of the coupon for distribution may be based upon the consumer's purchase history or the consumer's demographic information. The coupon for distribution could also be a pre-selected default coupon that is selected independent of the consumer specific information provided or if no consumer specific information is available. The in-store database may also communicate with an offsite database for selection of the coupon for distribution.

In a preferred embodiment, the inventive method of distributing coupons targets past purchasers of a manufacturer's product by examining a consumer's purchase history or demographic profile and distributing coupons based upon that purchasing history. The inventive method also targets consumer's of competitor products by evaluating a consumer's purchasing history and selecting a coupon that is best suited for that individual consumer's need. The inventive method distributes coupons via a consumer's in-store photo processing order. Finally, the inventive method provides targeted promotional offers to consumers before they complete their shopping by providing coupons with a consumer's completed photo finishing order.

### 5. BRIEF DESCRIPTION OF THE INVENTION

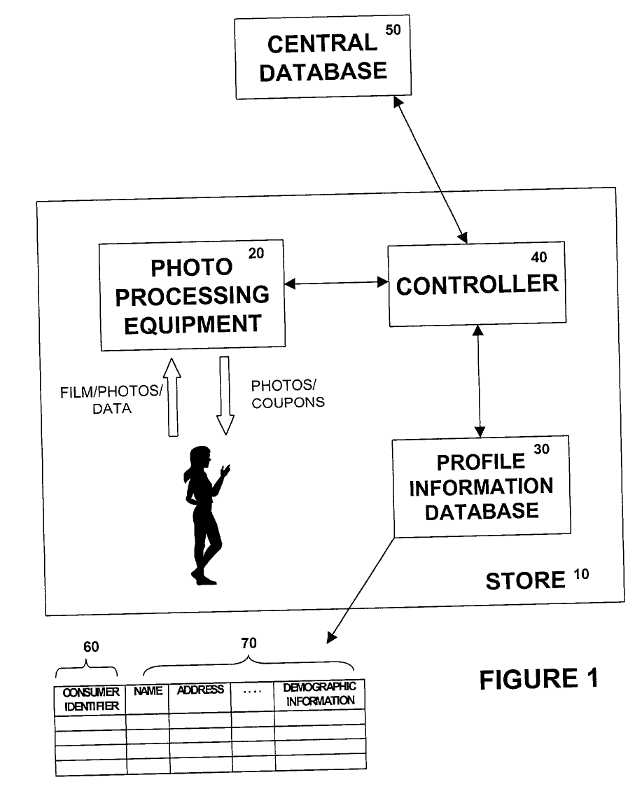

FIG. 1 is a schematic and block diagram of a system according to the invention, capable of performing the inventive method.

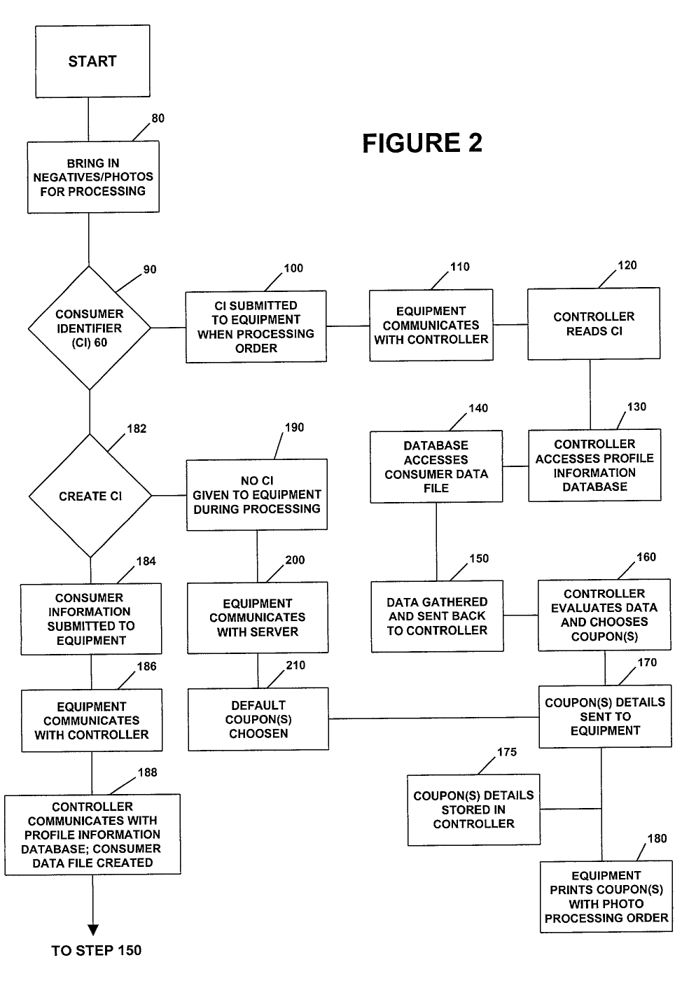

FIG. 2 is a flow chart showing the inventive method.

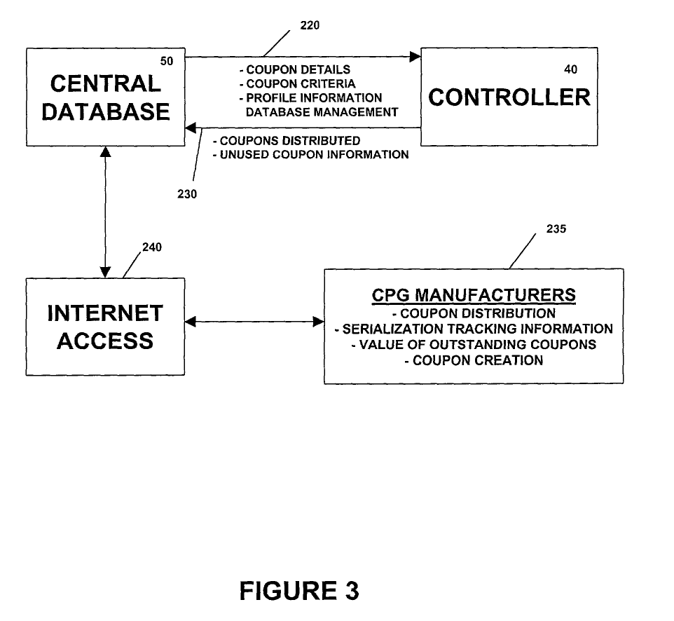

FIG. 3 is a block diagram view showing data flows.

### 6. DETAILED DESCRIPTION OF PREFERRED EMBODIMENTS

FIG. 1 shows a store 10 employing the inventive method. Store 10 includes photo processing equipment 20, profile information database 30 and controller 40. Also shown in FIG. 1, but not contained within store 10, is an offsite central database 50.

Store 10 is any business that offers on-site photo processing services. Photo processing services include development of film negatives into photo prints and producing standard and novelty prints from existing photos or from files captured from a digital camera or other equipment. Photo processing equipment 20 includes photo mini-labs and photo kiosks and any other equipment for processing photographs from negatives, digital cameras, or other digital media, or creating standard or novelty prints.

Photo mini-labs include equipment located at store 10 that provides the capability to process film negatives into photographs. Mini-labs may also have the capability of creating standard or novelty prints from existing photos. Mini-labs may be digital or digital/analogue hybrids.

Photo kiosks are systems that consist of a PC with a scanner and a touch-screen monitor, all enclosed in a free-standing case. Kiosks are configured for consumer operation and for making standard and novelty prints from existing photos. Kiosks are easy-to-use, low cost and have a small physical footprint. Kiosks allow any business without on-site photo minilabs to offer limited photo services. By adding low cost “coupon printers” to the kiosk, the central database 50 can provide coupons to the in-store photo kiosks.

Profile information database 30 is a database located in store 10. Information database 30 contains information regarding consumers and their purchasing habits. Consumers using photo processing equipment 20 may have a consumer identifier 60. This identifier 60 may be the same number used by store 10 in conjunction with a preferred customer program or loyalty card program. If store 10 does not have a preferred customer program or loyalty card program, the consumer information detailed below may be inputted and stored in information database 30 at the point of photo processing. In this latter situation, a consumer identifier 60 may be assigned by central database 50 for future use with photo processing.

The consumer data 70 included in the information database 30 may be accessed via a consumer identifier 60. The consumer identifier 60 enables equipment 20 to access the consumer data 70 in the information database 30. Consumer's data 70 includes consumer identifier 60, name, address, phone number, preferred customer program or loyalty card program information and demographic information. Preferred customer program or loyalty card program information may include the consumer's purchasing history and any other information typically included in these types of program databases. The demographic information may contain some or all of the following information about the consumer: age, sex, household income, pets (type and number), kids (number and ages), education, marital status, work status, hobbies, cars, home ownership status, place of birth. The demographic information that may be stored in information database 30 is not limited to this information. Any information that will enable central database 50 to determine the type of coupon to be distributed could be contained in information database 30. If store 10 does not have an information database 30 or loyalty card program, this database 30 can be created by central database 50.

Controller 40 is provided to connect photo processing equipment 20 to profile information database 30. Controller 40 also connects equipment 20 and information database 30 to central database 50. Controller 40 can be any system that allows communication between equipment 20, information database 30 and central database 50. Controller 40 is located in store 10. Controller 40 is capable of transferring data between equipment 20, information database 30 and central database 50. Controller 40 includes the following features: data transfer, targeting, security and connectivity database information.

Data transfer includes coupon download, data uploads, coupon information for printing, connection to information database 30 and network connectivity. Coupon download is a data transfer from central database 50 to controller 40 and then to equipment 20. Data uploads allows data transfer between equipment 20 and information database 30 via controller 40 and also from controller 40 to central database 50. Coupon information for printing is received from central database 50, stored in controller 40 and then transferred to equipment 20 after equipment accesses controller 40 to obtain coupon information.

The targeting aspect of controller 40 allows controller 40 to communicate with information database 30, obtain consumer data and determine which set of coupon information should be relayed back to equipment 20 for printing with the photo processing order. The coupon information is obtained from central database 50.

Security provides encryption/decryption capabilities between controller 40 and central database 50. These capabilities ensure the integrity of the inventive method and avoid coupon fraud. Security also allows coupon serialization. Coupon serialization, discussed in greater detail hereinbelow, is a fraud protection feature that limits potential fraud such as coupon counterfeiting.

Database information on controller 40 includes information regarding the number of coupons distributed and types of consumers enlisting the method of distributing coupons. This information is shared with central database 50.

Central database 50 is a centralized intelligent ad delivery network used to deliver targeted coupons to consumers at the time of photo processing. Central database 50 is secure and where fraud prevention, tracking and all data transfers, and reporting originates. Using the data generation section of central database 50, users will have the ability to generate real time reports showing coupon and customer statistics. Central database 50 has the ability, via controller 40, to link to photo processing equipment 20 and profile information database 30, select an appropriate coupon, tell photo processing equipment 20 to print the coupon(s) and include the coupon(s) in the order, for example only, as the order's “first photo,”. Central database 50 has the ability to create profile information database 30 for stores 10 that do not have a consumer database or loyalty card program. Central database 50 has the following features, data transfer, coupon controls, security and data reporter.

Central database 50 data transfer includes coupon download, serialization download and upload, client application updates, data upload and client connectivity and coupon creation via personal computer. Coupon download provides detailed information to controller 40 about the coupons that will be distributed at the point of photo processing. Serialization download and upload provides information between controller 40 and central database 50 regarding coupons distributed and used. Client application and connectivity allows current, up-to-date information to be delivered between controller 40 and central database 50. Data upload allows controller 40 to communicate with central database 50.

Central database 50 coupon controls include coupon builder and distribution control. Coupon builder provides UPC information for the coupons, as well as, any additional information that enables the user to create the coupon for distribution, for example only, the text of the coupon to be distributed with the consumers photo processing order. Coupon builder allows the retailer/advertiser to access central database 50 and remotely create coupon(s) via the information that resides on central database 50. Coupon builder may also contain graphics and other information regarding the product(s) that is the subject of the coupon(s). Distribution control allows the user to turn the coupon distribution on or off, modify the offer, keep track of coupons distributed, and track a store's use of coupons.

Central database 50 security features include serialization, coupon encryption, database encryption/decryption and access settings. Serialization information includes a range of numbers generated by central database 50 for the various coupon categories. Central database 50 shares the serialization information with controller 40 and a specific coupon serialization number is dynamically generated at the time each coupon is printed. Coupon serialization information may be printed on both sides or only one side of coupon. Coupon serialization information can be monitored by central database 50 via controller 40. Coupon encryption and database encryption/decryption ensure system integrity from fraud. Access settings controls store access to central database 50.

Central database 50 data reporter features include CPG (consumer packaged goods) center and network center. CPG center provides information for manufacturers regarding the distribution of the coupons, serialization tracking information and the values of outstanding coupons distributed but not yet redeemed. Network center provides update information and coupon classification tracking information.

Referring now to FIG. 2, the inventive method will be explained. In step 80, a consumer visits a store 10 to have photos processed. The photo work may entail the development of negatives into prints, or standard or novelty prints made from existing photo prints. The photo work may also be printing standard or novelty prints from data downloaded from a digital camera or other digital equipment. In decision block 90, the consumer opts to provide their consumer identifier 60 (scanned or manually). In step 100, the consumer identifier 60 is inputted into the photo processing equipment 20 at the time of photo processing. The photo processing equipment 20 communicates with the controller 40 (step 110) and in step 120 the controller 40 reads the database number 60 from the equipment 20. In step 130, the controller 40 connects to the profile information database 30 and accesses the information database. In step 140, the information database accesses the consumer data 70 using the consumer identifier 60 and retrieves that consumer's particular shopping history and/or demographic information. The information database 30 then reports the consumer's information back to the controller 40 (step 150). In step 160, the controller 40 evaluates the consumer data 70 and determines the appropriate coupon from the information previously obtained from the central database 50. In step 170, the controller 40 again communicates with equipment 20 and provides the detailed information regarding which coupon(s) should be printed and added with the consumer's photo processing order. In step 175, the coupon information is stored in controller 40. The equipment 20 then prints the coupon and the coupon is inserted with the photo processing order (step 180).

In decision block 182, if consumer does not have a consumer identifier 60, the consumer may choose to create a consumer data 70 file to be maintained in information database 30. In step 184, consumer's data 70 is submitted to equipment 20 when processing the consumer's order. The equipment 20 communicates with controller 40 in step 186 and transfers the new consumer data 70. In step 188, controller 40 then communicates with profile information database 30 and transfers consumer's data 70 to create the new file in database 30. Coupon distribution then continues with step 150 as previously explained. During communications with central database 50, step 220, central database 50 creates a consumer identifier 60 for the new consumer data 70 file and communicates this new identifier to the profile information database 30.

Alternatively, if the consumer does not have a consumer identifier 60 and chooses not to create a consumer data file 70 or opts not to provide their identifier 60 (step 190), equipment 20 will communicate to controller 40 that no number was provided (step 200). In this instance, as done in step 170, controller 40 provides the coupon information to equipment 20 for printing (step 210). The coupon information is stored in the controller (step 175).

Steps 80 through 210 occur while the photo processing order is being completed. The default coupon information, and choice of available coupon(s) for printing, is provided by central database 50 during one of the times that central database 50 communicates with controller 40.

If store 10 does not have a profile information database 30, central database 50 can create and maintain this database 30. Steps 184 through 188 set forth the process of creating consumer data 70 files once central database 50 creates the profile information database (step 220).

Referring now to FIG. 3, connectivity between central database 50 and controller 40 may come through a high speed, shared and/or dial-up or wireless connection. In one embodiment, connectivity between central database 50 and controller 40 will happen automatically several times daily. For example, in the morning, central database 50 downloads the day's promotions (220), which are encrypted and embedded into the controller 40 for security. Profile information database 30 management, such as assigning consumer identifier numbers 60 and maintaining database 30, also occurs during communications with controller 40 and central database 50. During the afternoon, a connection is made to upload encrypted current activity 230 (coupons distributed and unused coupon information), and once more in the evening for system update and complete data reconciliation. The number of times controller 40 communicates with central database 50, however, will ultimately depend upon each individual store and that store's coupon/photo processing needs. The CPG manufacturers can create, modify and monitor couponing (numbers, regions, retailers) 235 via a secure website 240. Retailers can do the same, though information available to retailers will be limited to information specific to their account.

We claim:

1. A method for distributing a coupon to a consumer via in-store photo finishing equipment comprising the step of configuring the coupon to be redeemable in-store.

2. The method according to claim 1 further comprising the steps of:
(a) providing a database having data associated with the consumer;
(b) accessing an in-store profile information database to retrieve consumer profile information based upon the specific consumer profile information obtained in step (a);
(c) selecting a coupon for distribution based upon the information provided in step (b);
(d) distributing the coupon to the consumer via the completed photo processing order.

3. The method according to claim 2 wherein step (c) further comprises the step of the in-store database communicating with an offsite database for selection of the coupon to distribute.

4. The method according to claim 2 wherein the profile information database contains consumer specific purchasing history and consumer specific demographic information.

5. The method according to claim 4 wherein step (c) further comprises the step of examining the profile information database to determine the consumer's purchase history and selecting a coupon based upon the consumer's purchase history.

6. The method according to claim 4 wherein step (c) further comprises the step of examining the profile information database to determine the consumer's demographic information and selecting a coupon based upon the consumer's demographic information.

7. The method according to claim 2 wherein step (c) further comprises the step of selecting a coupon based upon a pre-determined default coupon.

8. Method for distributing coupons to a consumer via in-store photo finishing equipment, photo mini-lab, photo kiosk or the like, comprising:
(a) obtaining specific consumer profile information during the process of completing a photo processing order;
(b) accessing an in-store profile information database to retrieve consumer profile information based upon the specific consumer profile information obtained in step (a);
(c) selecting a coupon for distribution based upon the information provided in step (b);
(d) printing the coupon for in-store use;
(e) distributing the coupon to the consumer via the completed photo processing order.

9. The method according to claim 8 wherein step (c) further comprises the step of the in-store database communicating with an offsite database for selection of the coupon to distribute.

10. The method according to claim 8 wherein the profile information database contains consumer specific purchasing history and consumer specific demographic information.

11. The method according to claim 10 wherein step (c) further comprises the step of examining the profile information database to determine the consumer's purchase history and selecting a coupon based upon the consumer's purchase history.

12. The method according to claim 10 wherein step (c) further comprises the step of examining the profile information database to determine the consumer's demographic information and selecting a coupon based upon the consumer's demographic information.

13. The method according to claim 8 wherein step (c) further comprises the step of selecting a coupon based upon a pre-determined default coupon.

14. Method for distributing coupons to a consumer via in-store photo finishing equipment, photo mini-lab, photo kiosk or the like, comprising:
(a) obtaining specific consumer profile information during the process of completing a photo processing order;
(b) accessing an in-store profile information database to retrieve consumer profile information based upon the specific consumer profile information obtained in step (a) wherein the profile information database contains consumer specific purchasing history;
(c) selecting a coupon for distribution by examining the profile information database to determine the consumer's purchase history and selecting a coupon based upon the purchase history;
(d) printing the coupon for in-store use;
(e) distributing the coupon to the consumer via the completed photo processing order.

15. The method according to claim 14 wherein step (c) further comprises the step of the in-store database communicating with an offsite database for selection of the coupon to distribute.

16. Method for distributing coupons to a consumer via in-store photo finishing equipment, photo mini-lab, photo kiosk or the like, comprising:
(a) obtaining specific consumer profile information during the process of completing a photo processing order;
(b) accessing an in-store profile information database to retrieve consumer profile information based upon the specific consumer profile information obtained in step (a) wherein the profile information database contains consumer specific demographic information;
(c) selecting coupon for distribution by examining the consumer profile information to determine the consumer's demographic information and selecting a coupon based upon the demographic information;
(d) printing the coupon for in-store use;
(e) distributing the coupon to the consumer via the completed photo processing order.

17. The method according to claim 16 wherein step (c) further comprises the step of the in-store database communicating with an offsite database for selection of the coupon to distribute.

18. Method for distributing coupons to a consumer via in-store photo finishing equipment photo mini-lab, photo kiosk or the like, comprising:
(a) obtaining specific consumer profile information during the process of completing a photo processing order;
(b) accessing an in-store profile information database and the in-store database accesses an offsite database;
(c) selecting coupon for distribution by selecting a coupon based upon a pre-determined default coupon determined by the offsite database;
(d) printing the coupon for in-store use;
(e) distributing the coupon to the consumer via the completed photo processing order.

19. An apparatus for distributing a coupon to a consumer via in-store photo finishing equipment comprising a means for configuring the coupon to be redeemable in-store.

20. The apparatus according to claim 19 further comprising:
(a) means for providing a database having data associated with the consumer;
(b) means for accessing an in-store profile information database to retrieve consumer profile information based upon the specific consumer profile information obtained in step (a);
(c) means for selecting a coupon for distribution based upon the information provided in step (b); and
(d) means for distributing the coupon to the consumer via the completed photo processing order.

21. The apparatus according to claim 20 wherein step (c) further comprises the means for the in-store database communicating with an offsite database for selection of the coupon to distribute.

22. The apparatus according to claim 20 wherein the profile information database contains consumer specific purchasing history and consumer specific demographic information.

23. The apparatus according to claim 22 wherein step (c) further comprises the means for examining the profile information database to determine the consumer's purchase history and selecting a coupon based upon the consumer's purchase history.

24. The apparatus according to claim 22 wherein step (c) further comprises the means for examining the profile information database to determine the consumer's demographic information and selecting a coupon based upon the consumer's demographic information.

25. The apparatus according to claim 20 wherein step (c) further comprises the means for selecting a coupon based upon a pre-determined default coupon.

26. An apparatus for distributing coupons to a consumer via in-store photo finishing equipment, photo mini-lab, photo kiosk or the like, comprising:
(a) means for obtaining specific consumer profile information during the process of completing a photo processing order;
(b) means for accessing an in-store profile information database to retrieve consumer profile information based upon the specific consumer profile information obtained in step (a);
(c) means for selecting a coupon for distribution based upon the information provided in step (b);
(d) means for printing the coupon for in-store use;
(e) means for distributing the coupon to the consumer via the completed photo processing order.

27. The apparatus according to claim 26 wherein step (c) further comprises the means for the in-store database communicating with an offsite database for selection of the coupon to distribute.

28. The apparatus according to claim 26 wherein the profile information database contains consumer specific purchasing history and consumer specific demographic information.

29. The apparatus according to claim 28 wherein step (c) further comprises the means for examining the profile information database to determine the consumer's purchase history and selecting a coupon based upon the consumer's purchase history.

30. The apparatus according to claim 28 wherein step (c) further comprises means for examining the profile information database to determine the consumer's demographic information and selecting a coupon based upon the consumer's demographic information.

31. The apparatus according to claim 26 wherein step (c) further comprises the means for selecting a coupon based upon a pre-determined default coupon.

32. An apparatus for distributing coupons to a consumer via in-store photo finishing equipment, photo mini-lab, photo kiosk or the like, comprising:
(a) means for obtaining specific consumer profile information during the process of completing a photo processing order;
(b) means for accessing an in-store profile information database to retrieve consumer profile information based upon the specific consumer profile information obtained in step (a) wherein the profile information database contains consumer specific purchasing history;
(c) means for selecting a coupon for distribution by examining the profile information database to determine the consumer's purchase history and selecting a coupon based upon the purchase history;
(d) means for printing the coupon for in-store use;
(e) means for distributing the coupon to the consumer via the completed photo processing order.

33. The apparatus according to claim 32 wherein step (c) further comprises the means for the in-store database communicating with an offsite database for selection of the coupon to distribute.

34. An apparatus for distributing coupons to a consumer via in-store photo finishing equipment, photo mini-lab, photo kiosk or the like, comprising:
(a) means for obtaining specific consumer profile information during the process of completing a photo processing order;
(b) means for accessing an in-store profile information database to retrieve consumer profile information based upon the specific consumer profile information obtained in step (a) wherein the profile information database contains consumer specific demographic information;
(c) means for selecting coupon for distribution by examining the consumer profile information to determine the consumer's demographic information and selecting a coupon based upon the demographic information;
(d) means for printing the coupon for in-store use;
(e) means for distributing the coupon to the consumer via the completed photo processing order.

35. The apparatus according to claim 34 wherein step (c) further comprises the means for the in-store database communicating with an offsite database for selection of the coupon to distribute.

36. An apparatus for distributing coupons to a consumer via in-store photo finishing equipment photo mini-lab, photo kiosk or the like, comprising:
(a) means for obtaining specific consumer profile information during the process of completing a photo processing order;
(b) means for accessing an in-store profile information database and the in-store database accesses an offsite database;
(c) means for selecting coupon for distribution by selecting a coupon based upon a pre-determined default coupon determined by the offsite database;
(d) means for printing the coupon for in-store use;
(e) means for distributing the coupon to the consumer via the completed photo processing order.
